(19) United States
(12) Patent Application Publication
(10) Pub. No.: US 2025/0390376 A1
(43) Pub. Date: Dec. 25, 2025

(54) AUTO-REMEDIATION OF A FAILED NODE

(71) Applicant: Dell Products, L.P., Round Rock, TX (US)

(72) Inventors: Apu Mandal, Plymouth, MN (US); Steven Soumpholphakdy, Austin, TX (US)

(21) Appl. No.: 18/748,884

(22) Filed: Jun. 20, 2024

(51) Int. Cl. G06F 11/07

(52) U.S. Cl. CPC G06F 11/0793; G06F 11/0709; G06F 11/0787; G06F 11/079

(57) ABSTRACT

The described technology is generally directed towards dynamically, and automatically, determining cause of failure regarding a node (aka orphan node) no longer being included in a cluster of nodes originally configured to operate in conjunction with the orphan node. An operation log can be compiled for the orphan node at the time the separation occurred. The log can be compared with signatures comprising previously identified split conditions and associated action(s) taken to reconnect an orphan node with a cluster of nodes. In the event of a prior signature matches the log, the associated action can be applied to the current orphan node to re-merge the orphan node with the cluster of nodes. In the event of no prior signature is found to match the log, operational analysis of the orphan node can be forwarded to technical support for further determination of the cause of the orphan status of the node.

### BACKGROUND

Situations can arise where a node, participating in a clustered filesystem, undergoes an unexpected failure and splits from a cluster of nodes originally configured to include the failed node. Example scenarios can include sever panic, hardware failure, or an issue experienced during a boot process operation, such as triggered by a panic, a reboot operation, a node misconfiguration, and suchlike. The node can still be functional, but, owing to the unexpected failure, the node is not re-merged into the cluster of nodes. Effectively, the node becomes an orphan node.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to automatically remediate a failed node and mitigate one or more effects of the node failing.

According to one or more embodiments, a system is presented, wherein the system comprises at least one processor, and at least one memory coupled to the at least one processor and having instructions stored thereon, wherein the system can be configured to automatically remediate a failed node and mitigate one or more effects of the node failing. In response to the at least one processor executing the instructions, the instructions facilitate performance of operations, comprising receiving an operation log, wherein the operation log is received from a node and comprises content detailing a failed operation of the node, comparing first content of the operation log with second content of a signature, wherein the signature has an associated remediation action, and in response to determining that the first content of the operation log matches the second content of the signature, implementing the remediation action.

In an embodiment, the operation log can indicate the node is in a first condition, wherein the first condition can be the node being orphaned from a node cluster configured to include the node, wherein the remediation action places the node in a second condition, and wherein the second condition can be the node is re-merged with the node cluster.

In a further embodiment, the first content of the operation log can comprise a first set of items, wherein each item in the first set of items can have a respective timestamp, and the second content of the signature comprises a second set of items, wherein each item in the second set of items can have a respective timestamp. The operations can further comprise: determining that the first content of the operation log matches the second content of the signature based on: the first set of items being determined to match the second set of items and a first chronological order of the first set of items being determined to match a second chronological order of the second set of items.

In another embodiment, the signature can be a first signature included in a set of signatures, and wherein the operations can further comprise, in response to determining the first content of the operation log does not match the second content of the first signature: forwarding the operation log to an external review system, further receiving, from the external review system, a second signature generated based on the first content of the operation log, and further supplementing the set of signatures with the second signature.

In a further embodiment, the operation log can indicate the node is orphaned from a node cluster configured to include the node, and the remediation action can comprise one of re-merging the node into the node cluster, replacing the orphaned node in the node cluster with a different node, or reconfiguring operation of computing equipment comprising the node cluster.

In an embodiment, the operation log can be auto-generated by the node, and the system can be remotely located from the node.

In another embodiment, the node can be located in a computer system, and the node can be one of a container node, a virtual machine, an application server, a data server, or a user device.

In another embodiment, the operations can further comprise (a) transmitting the remediation action to the node for implementation of the remediation action at the node, (b) transmitting the remediation action to a cluster control process located at the node cluster for implementation of the remediation action at the node cluster, or (c) transmitting the remediation action to a cloud control process for implementation of the remediation action at a cloud computing system that comprises the node.

In a further embodiment, the failed operation of the node causes the node to be orphaned from a node cluster configured to include the node, and the node is unable to communicate with another node in the node cluster.

In an embodiment, the remediation operation can comprise rebooting the node.

In further embodiments, a computer-implemented method is provided, wherein the method comprises comparing, by a device comprising at least one processer, first content of an operation log with second content of a signature, wherein the operation log can be received from a node in a first condition comprising a failed condition, wherein the signature can be generated from a previously failed node, wherein the first content of the operational log can be in a first chronological sequence, and wherein the second content of the signature can be in a second chronological sequence, and in response to determining, by the device, that the first chronological sequence of the first content matches the second chronological sequence of the second content: indicating, by the device, the first content and the second content match, and further implementing, by the device, a remediation action associated with the signature.

In an embodiment, the first condition of the node is the node is orphaned from a node cluster configured to include the node, and a second condition of the node is the node is operational within the node cluster.

In a further embodiment, wherein the device is located remote from the node, and the node is unable to communicate with other nodes in the node cluster from which the node is orphaned.

In another embodiment, the first condition of the node can cause at least one of a node cluster configured to include the node to operate in a degraded state, a file system configured to include the node operates in a degraded state, or a cloud computing system configured to include the node operates in a degraded state. In a further embodiment, the remediation action can comprise at least one of re-merging the node into the node cluster, replacing the orphaned node in the node cluster with a different node, or reconfiguring operation of at least one of the node cluster, the file system, or the cloud computing system.

Further embodiments can include a computer program product stored on a non-transitory computer-readable medium and comprising machine-executable instructions, wherein in response to being executed, the machine-executable instructions cause a system to perform operations, comprising determining that first content of an operation log matches second content of a signature, wherein the operation log is received from a node currently orphaned from a node cluster configured to operate with the node and the signature represents an action generated during prior remediation of a previously orphaned node, and wherein the first content of the operational log is in a first chronological sequence and the second content of the signature is in a second chronological sequence, and in response to determining that the first chronological sequence of the first content matches the second chronological sequence of the second content, implementing the action associated with the signature.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1A presents an example system configured to automatically determine an operational status of a node and further re-merge the node with a node cluster originally configured to operate with the node, in accordance with one or more embodiments.

FIG. 1B presents an example schematic further developing concepts and embodiments presented regarding the node-implemented system presented in FIG. 1A, in accordance with one or more embodiments.

FIG. 2 illustrates a matching process between content of an operational log and content of one or more signatures, in accordance with an embodiment.

FIG. 3 presents a sequence diagram illustrating respective steps/operations performed during remediation of an orphaned node, in accordance with one or more embodiments.

FIG. 4 presents an example computer-implemented method for automatically remediating a consequence of a failed node in a node cluster, in accordance with one or more embodiments.

FIG. 5 presents an example computer-implemented method for determining remediation of a node and re-training of a process to automatically remediate the node, in accordance with one or more embodiments.

FIG. 6 presents an example computer-implemented method for automatically remediating a consequence of a failed node in a node cluster, in accordance with one or more embodiments.

FIG. 7 presents an example computer-implemented method for automatically remediating a consequence of a failed node in a node cluster, in accordance with one or more embodiments.

FIG. 8 presents an example computer-implemented method for automatically remediating a consequence of a failed node in a node cluster, in accordance with one or more embodiments.

FIG. 9 presents an example computer-implemented method for automatically remediating a consequence of a failed node in a node cluster, in accordance with one or more embodiments.

FIG. 10 presents an example environment for implementing various embodiments presented herein.

FIG. 11 illustrates an example wireless communication system, in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

### 1. Overview

As previously mentioned, scenarios can arise where a node, configured to participate in a cluster of nodes/clustered filesystem, undergoes an unexpected failure and the node effectively splits/separates from the cluster of nodes, placing the node in an orphaned condition. The orphaned node is still functional, e.g., the node can still boot up. Loss of the node from the node cluster can place the node cluster in a degraded/less-than-optimal condition compared with operation of the node cluster when in an original/anticipated configuration which includes the node, e.g., the node is not in an orphaned state.

Example failure scenarios include panics, hardware failure, power disruption, or issues encountered during the boot process (e.g., triggered by a panic, a reboot operation, a misconfiguration, and the like). The term panic is used herein to describe a node(s) that has crashed/stopped in an uncontrolled manner, with a potential for incorrect/partial boot, while communication/connectivity with the node is still possible (e.g., node can be pinged). Per an embodiment presented herein, after a panic event, a node can be automatically brought back online and re-incorporated into the node cluster with the node, and the node cluster, returning to full functionality.

Per the various embodiments presented herein, an example scenario of application/implementation involves the node still being functional but split/orphaned from a node cluster originally configured to include the orphaned node. In an aspect, the orphaned node does not have the functionality/facility to generate notifications/events to the one or more nodes remaining in the cluster. Such a scenario can be encountered when a node had been part of a cluster, for one reason or another, the node was rebooted, but the node was never re-merged back into the cluster (e.g., the node undergoes a stop boot condition).

Further, the various embodiments presented herein can be configured to solve situations during early boot before all the various services are up and running (e.g., monitoring and notification services). Conventionally, in such situation, remediation involves some form of technical support/engineering entity to root cause the issue, and corrective action to make the cluster whole again cannot be performed until the root cause of the node split is understood. Technical support may utilize a serial console communication interface to interact with/troubleshoot the orphaned node, however, the interaction requires engagement by the tech support system with the node.

With the various embodiments herein, a node can be configured to notify an analysis component (e.g., a failure analysis component) that the node has split from a cluster, and further provide information regarding the operation/conditions of the node prior to and/or when, the split occurred. The analysis component can be located off-cluster and configured to (a) analyze and process information provided by the failing node, (b) determine if the node failed due to any known signature of failure, and in the event of the failure of the node is comparable to a known signature, (c) route failure analysis/remediation internally from the analysis component to the node to initiate orchestration to auto-remediate the failure issue at the node, and thus, (d) move the node cluster out of the degraded state, e.g., by re-merging the node into the node cluster, taking the node offline, and the like.

In an example scenario where the node is operating in a cloud server environment/application, various fault scenarios can arise. A fault can result from a scheduled maintenance of cloud resources, the issue can be ascribed to the maintenance operation and there is nothing further to investigate. The fault arising from the maintenance operation may have occurred before, and a known signature describing the fault is previously captured.

Hence, if a failure signature can be generated (e.g., as an operation log) for a current failure and confirmed against a known failure signature(s), it is possible to limit the amount of time that a node cluster is in a degraded state, thereby minimizing impact on a customer's activities at the node cluster. In another example of implementation, a known issue (e.g., software bug, misconfiguration, and the like) caused the node split, and a plan is in place to deliver, to the customer, a patch addressing the issue, but that patch has yet to be rolled out. In the interim, the node can be remediated by matching with a known signature/action.

The various embodiments herein enable proactive remediation of a potential customer issue/experience without having to review/access/modify (e.g., xml files) of an operating system (OS) of the node or the node cluster.

Accordingly, compared with a conventional incident report/escalation workflow, the various embodiments can reduce a need/number of calls for support intervention for known issues, reduce time to resolution, reduce the amount of time a node cluster and/or a customer service is potentially in a degraded state, and further roll-out auto-remediation workflows without requiring changes on the failing node or affected node cluster.

In the event of no match is determined between an operational log of a failed node and one or more signatures, the operational log can be sent for further review, e.g., by technical support, a human entity.

### 2. Node Remediation System

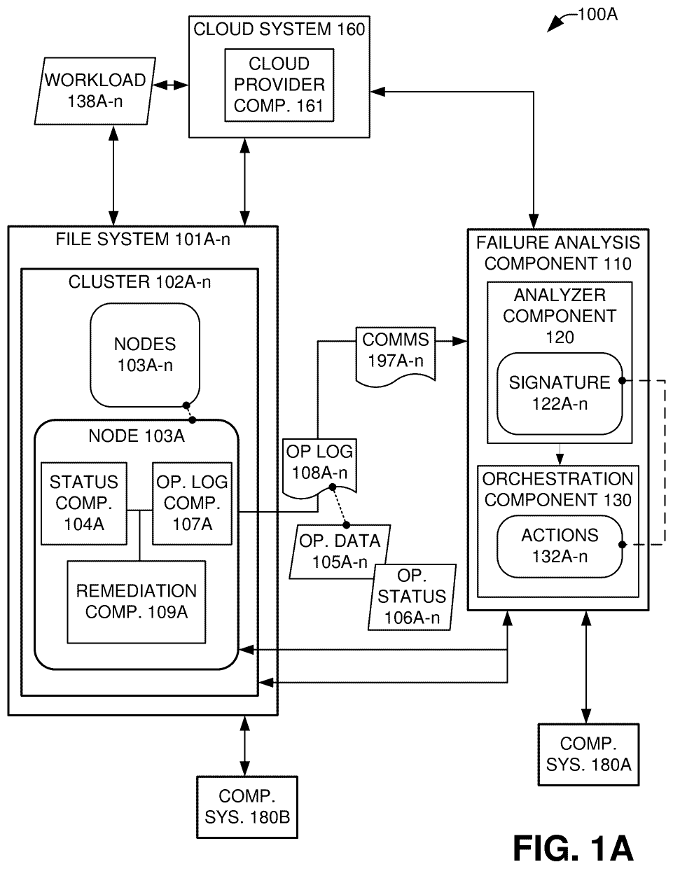

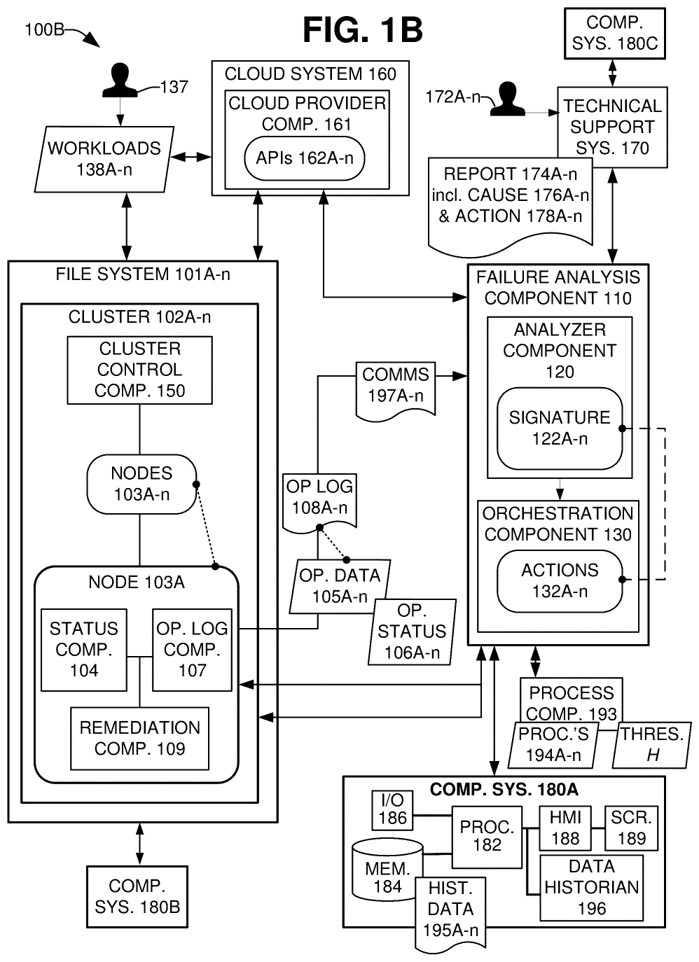

FIG. 1A, presents an example schematic of a system 100A configured to automatically determine an operational status of a node and further re-merge the node with a node cluster originally configured to operate with the node, in accordance with one or more embodiments. The term n, as used herein is any positive integer.

As shown, system 100A can include a file system 101A-n, whereby file system 101A-n can further include one or more node clusters 102A-n comprising one or more clusters/sets of nodes 103A-n. In an embodiment, a file system can map one-to-one with a cluster, such that, for example, a file system 101A maps to node cluster 102a. The file system 101A-n can be any computing system configured to process/implement one or more workloads 138A-n, e.g., a data storage system, cloud computing system/equipment, a cloud storage system, a container orchestration system, a Hadoop Distributed File System (HDFS), a user device, and the like. Nodes 103A-n can be computers, data servers, application servers, virtual machines (VMs), container nodes, user device(s), etc., configured to implement the one or more workloads 138A-n. A node cluster 102A-n can comprise a set/group of two or more nodes 103A-n collaborating to provide workload balancing, workload failover, etc., of the one or more workloads 138A-n. While a node cluster 102A-n can comprise two or more nodes 103A-n, a likely scenario is a set of three or more nodes, e.g., 103A/103B/103C, such that, in the event of node 103A splits from the node cluster 102A, node cluster 102A still comprises a cluster/operates with the two nodes 103B and 103C. In an example configuration, a node cluster 102A is originally configured with a set of nodes 103A-n, wherein node 103A is included in the configuration of node cluster 102A. Furthering the example configuration, as previously mentioned, owing to a reboot failure, and the like, node 103A becomes orphaned from the node cluster 102A, and the various embodiments further present systems, methods, etc., to re-merge node 103A into the node cluster 102A, reconfigure node cluster 102A to function without node 103A, adjust operation/configuration of respective devices and components included in file system 101A-n/cloud computing system 160, etc.

In an embodiment, each node 103A-n can respectively include a status component 104A-n, wherein status component 104A-n can be configured to monitor operational data 105A-n generated/provided at the node 103A-n and determine, from data 105A-n, an operational status 106A-n of the respective node 103A-n. In a further embodiment, each node 103A-n can respectively include an operational log component 107A-n (a.k.a., log component), wherein a log component 107A-n can be configured to monitor and compile an operational log 108A-n for the respective nodes 103A-n, wherein the respective log 108A-n includes the respective status 106A-n and associated data 105A-n for a particular node 103A-n. For example, status component 104A operating on node 103A can be configured to monitor operation of node 103A in accordance with operation of the node cluster 102A-n.

With data 105A-n indicating normal/expected operation of node 103A, the status component 104A maintains the operational status 106A-n of node 103A as normal. However, in the event of node 103A splits from the node cluster 102A (e.g., during a partial boot operation), status component 104A determines node 103A is operating as an orphan node and is no longer operating in a manner where node 103A is incorporated/merged with the other nodes 103B-n in node cluster 102A. Accordingly, status component 104A determines the status 106A of node 103A is in a fail condition. Further, the status component 104A can be configured to instruct (e.g., in a communication 197A-n, as further described) the log component 107 to compile an operation log 108A-n (a.k.a., log) providing details of operation (e.g., from data 105A-n) of the node 103A/node cluster 102A for a time period T up to and including the moment at which the status component 104A determined node 103A is in the fail condition, status 106A.

Upon generation of log 108A for node 103A, the status component 104A (or the log component 107) can be further configured to forward/transmit log 108A to a failure analysis component (FAC) 110, wherein the FAC 110 can be off-cluster (e.g., remotely located to node 103A and cluster 102A) and communicatively coupled to any of node cluster 102A-n, nodes 103A-n, status component 104A-n, and/or log component 107A-n. As further described, FAC 110 can be configured to auto-remediate operation of node 103A and/or return cluster 102A to an original configuration (e.g., with or without node 103A).

In an example embodiment, status component 104A can utilize a script, e.g., isi_stop_boot script, which is invoked when node 103A fails and further stops booting of the node 103A and/or node cluster 102A-n, e.g., boot of node 103A is halted and node 103A drops into a shell. Per the various embodiments presented herein, capabilities of the script utilized by the status component 104A can be expanded, such that, in the event of a node 103A goes into a single-user/orphan mode, the log component 107A can be invoked to compile log 108A. In a further example embodiment, where a log component 107A-n is respectively included in/operating at each node 103A-n, the log component 107A-n can be bootstrapped (e.g., during cluster deployment time of node cluster 102A-n) with information regarding how to communicate with the FAC 110 (e.g., provided with FAC 110 IP address, credentials, etc.) to offload log 108A-n to the FAC 110.

As shown, FAC 110 can include an analyzer component 120 and an orchestration component 130. Analyzer component 120 can be configured to include a set/series of signatures 122A-n (a.k.a., root cause analyses, RCAs, schema). Signatures 122A-n can comprise an ordered schema/list of items/events that occurred during the prior incidence of a respective failure of a node 103A-n, e.g., signature 122B is generated during remediation of a prior failure of node 103B. As further described below, the items (e.g., items 210A-n and 230A-n) can also have an associated timestamp (e.g., timestamps 220A-n and 240A-n), enabling the chronological sequence of the item's occurrence to be determined, such that as well as performing a match based on a presence of items in a log 108A and signature 122A (e.g., based on regular expression matching), the sequence of the items in the log 108A and signature 122A can also be paired/confirmed. As further described, per FIG. 1B, in the event of no-match occurring between items in log 108A and signatures in the set of signatures 122A-n, log 108A can be forwarded to technical support (e.g., tech support system 170) for further review.

Orchestration component 130 (a.k.a., an orchestration engine) can be configured to include a set/series of actions 132A-n (a.k.a., remediations, remediation workflows, auto-remediation workflows, orchestration workflows, workflow schema, activities), wherein a respective action 132A-n can be defined for a respective signature 122A-n, e.g., action 132A is assigned to signature 122A, action 132n is assigned to signature 122n, and the like. As further described, a signature 122A-n and associated action 132A-n can be a schema generated in response to a prior issue with a node 103A-n (e.g., node 103P was previously determined to be in a fail condition) and how the issue was resolved regarding re-merging of node 103P into the node cluster 102P, moving node cluster 102P out of a degraded state, etc. Signatures 122A-n and actions 132A-n can be compiled for any of the nodes 103A-n/node clusters 102A-n, such that a signature 122P/action 132P may have been generated for prior remediation of node 103P/node cluster 102P, however, signature 122P/action 132P may pertain/be relevant to remediation of a current operational failure being experienced by node 103A/node cluster 102A.

FAC 110 (and analyzer component 120/orchestration component 130) can be configured to identify a signature 122A-n matching the conditions presented in/content of log 108A, and in the event of a match is determined between any of the compiled signatures 122A-n and the log 108A, the action 132A-n associated with the signature 122A-n, e.g., a first action 132A is associated with first signature 122A, can be selected by the FAC 110 for implementation, e.g., at node 103A, at node cluster 102A, or, in the event of the file system 101A-n is a cloud-based computer system 160, implemented at a cloud control component 161 controlling operation of the cloud-based system 160 pertaining to node 103A.

In an example embodiment, node 103A can further include a remediation component 109A configured to receive the matched action 132A, and further apply action 132A at the node 103A to enable node 103A to be re-merged into the node cluster 102. As further described, remediation action 132A-n can also be implemented/directed to the one or more nodes 103A-n, the node cluster 102A-n, at the file system 101A-n, and/or at the cloud provider level, e.g., as required, to enable (a) node 103A to be re-merged into the node cluster 102A, (b) reconfigure the node cluster 102A to perform the required functionality/workload processing without node 103A, such as node 103A is replaced by another available node 103B-n, (c) configure node 103A and/or node cluster 102A to mitigate/minimize any deleterious impact of the failure of node 103A on one or more operations (e.g., for a customer 137) to be performed at node cluster 102A or node 103A, etc. Further example actions 132A-n include, in a non-limiting list, (a) teardown the currently configured cloud resources (e.g., one or more devices/components in file system 101A-n/at cloud system 160 associated with node 103A) and start up a new set of cloud resources (e.g., responding to a blown journal node resulting from a known scheduled maintenance condition), (b) failure of node 103A-n can result from a misconfiguration which can be remedied by executing a set of commands, e.g., via secure shell (SSH), etc. By implementing the one or more actions 132A-n, a duration for which operation of a node cluster 102A, node 103A, file system 101A-n, etc., is degraded is minimized.

As further described, any components included in system 100 (e.g., node cluster 102, nodes 103A-n, status component 104A-n, log component 107A-n, remediation component 109, FAC 110, analyzer component 120, orchestration component 130, and such), can include/be communicatively coupled to a computer system 180A-n (e.g., computer system 180A/180B/180C).

Per the foregoing, status component 104A and/or log component 107A-n can be operationally incorporated into a respective node 103A-n, providing the node 103A-n with intelligence to self-monitor operation of the respective node 103A-n and initiate remediation of node 103A-n, etc. Alternatively, a status component 104A and/or the log component 107A can be operational across all of the nodes 103A-n in the node cluster 102A-n, enabling nodes 103A-n to initiate auto-remediation.

FIG. 1B presents an example schematic 100B further developing concepts and embodiments presented regarding the node remediation system presented in FIG. 1A, in accordance with one or more embodiments.

As shown in FIG. 1B, a node cluster 102A-n can comprise of a set of nodes 103A-n configured to process/support one or more workloads/computer processes 138A-n. As previously mentioned, a node 103A-n can respectively include one or more of a status component 104A-n, a log component 107A-n, and/or a remediation component 109A-n. Status component 104A can be configured to determine associated node 103A is in a fail condition (e.g., status 106A), in response thereto, log component 107A is configured to generate a log 108A comprising a log of the status 106A fail condition and respective information/conditions/data 105A-n pertaining to/describing the fail condition and operation of node 103A prior to/when the fail condition arose/was detected. Log 108A can include further information to enable off-cluster determination of whether a prior signature 122A-n matches information in log 108A, wherein the further information can include an identifier of the node 103A, node cluster 102, status 106A-n, data 105A-n, etc. Log 108A can be forwarded to the FAC 110.

As previously mentioned, a remediation action 132A-n can be applied at any required level, e.g., at the node 103A-n, at the node cluster 102A-n, at the file system 101A-n, at the cloud control component 161, with FAC 110 communicatively coupled to devices/components at the respective level. Accordingly, a node cluster 102A-n can include a cluster control component 150 configured to control operation of the one or more nodes 103A-n included in the node cluster 102A-n, and/or the node cluster 102A-n. Cluster control component 150 can be configured to receive, and implement, the remediation action 132A-n directed at node cluster 102A-n/nodes 103A-n. In another embodiment, with respective nodes 103A-n and node clusters 102A-n included/operational in a data center/cloud computing service, a cloud control component 161 can be configured to control operation of the cloud computer system 160, file system 101A-n, the nodes 103A-n, and/or node cluster 102A-n. The cloud control component 161 can include various cloud provider APIs 162A-n, wherein the APIs 162A-n can be configured to provide such functionality as delete a node 103A-n, start/initiate a node 103A-n, delete a remote disk (e.g., cluster 102A-n/file system 101A-n), add a remote disk (e.g., cluster 102A-n/file system 101A-n), etc., as required to mitigate/minimize any deleterious impact of the failure of node 103A on one or more operations (e.g., for a customer 137) to be performed at node 103A, node cluster 102A-n, file system 101A-n, cloud computing system 160A-n, etc.

As previously mentioned, in response to the analyzer component 120 determining that no prior signature 122A-n matches content (e.g., data 105A-n, status 106A-n) in log 108A, a further determination can be made/implied that, owing to no pertinent signatures 122A-n being found, insufficient information is provided in log 108A for remediation of node 103A to be automatically performed by any of the respective components included in FAC 110, cluster 102A-n, or operating at nodes 103A-n. In response to a determination by the analyzer component 120 that no known/prior signature 122A-n matches log 108A, the analyzer component 120 can be further configured to forward log 108A to a technical support system 170, where log 108A can be analyzed to further determine a cause(s) of the fail status 106A of node 103A. Technical support staff 172A-n (e.g., system engineer, and the like) can manually review log 108A to determine a cause(s) 176A-n of the fail condition of node 103A, and further, determine remediation action 178A-n implemented to address the fail condition of node 103A. Cause 176A-n and remediation action 178A-n can be presented/distributed in an analysis report 164A-n generated by technical staff 172 at tech support system 170.

In the event of a cause(s) 176A-n and a remediation action 178A-n for the fail status 106A-n of node 103A is determined/ascertained, the analysis report 174A-n can be provided to the analyzer component 120. The analyzer component 120 can be configured to supplement the current signatures 122A-n and associated actions 132A-n with cause 176A-n/remediation action 178A-n as a new signature 122Z/action 132Z. Hence, as operation of the node clusters 102A-n and nodes 103A-n proceeds, signatures 122A-n and actions 132A-n can be continually supplemented with fail condition information, causes 176A-n and remediations 178A-n, and the like.

A further previously mentioned, in response to the analyzer component 120 determining that a prior signature 122A-n matches content in log 108A, the orchestration component 130 can be configured to identify, and implement, the action 132A-n associated with the matching signature 122A-n. The action 132A-n can be provided (e.g., in an instruction 197A-n, as further described) to the remediation component 109, whereupon the remediation component 109 can be further configured to apply the action (e.g., action 132A) to the node, e.g., node 103A.

Various communications 197A-n can be utilized across system 100, between file system 101A-n (and included components), node cluster 102A-n (and included components), FAC 110 (and included components), cloud system 160 (and included components), technical support system 170, and computer system 180. Communications 197A-n can include notifications, instructions, status updates, selections, data, information (e.g., logs 108A-n, data 105A-n, status 106A-n, signatures 122A-n, actions 132A-n, reports 174A-n/causes 176A-n/remediations 178A-n, and such), and the like.

As shown in FIG. 1B, any of the components (e.g., file system 101A-n, node clusters 102A-n, FAC 110, analyzer component 120, orchestration component 130, cloud system 160, and the like), process component 193 (as further described below), etc., can be communicatively coupled to a computer system 180 (e.g., computer system 180A local to FAC 110, computer system 180B local to node 103A/node cluster 102A-n. computer system 180C local to tech support system 170). The respectively located computer system 180A-n can respectively comprise a processor 182 and a memory 184, wherein the processor 182 can execute the various computer-executable components, functions, operations, etc., presented herein, e.g., any of components in file systems 101A-n, node clusters 102A-n, status component 104A-n, log component 107A-n, remediation component 109, cluster control component 150, FAC 110, analyzer component 120, orchestration component 130, cloud system 160, cloud control component 161, process component 193, and such. The memory 184 can be utilized to store the various computer-executable components, functions, code, etc., as well as information regarding any of nodes 103A-n, data 105A-n, status 106A-n, logs 108A-n, signatures 122A-n, actions 132A-n, reports 174A-n, causes 176A-n, actions 178A-n, vectors V₁₋ₙ, similarity indexes S₁₋ₙ, processes 194A-n (as further described below), historical data 195A-n, and suchlike.

As further shown, computer system 180A-n can include an input/output (I/O) component 186, wherein the I/O component 186 can be a transceiver configured to enable transmission/receipt of information and data between any of the components included in system 100. I/O component 186 can be communicatively coupled to the remotely located devices and systems, e.g., technical support system 170, cloud system 160. In an embodiment, I/O component 186 can be configured to transmit various communications 197A-n regarding data 105A-n, status 106A-n, logs 108A-n, signatures 122A-n, actions 132A-n, reports 174A-n, causes 176A-n, actions 178A-n, e.g., regarding operation of nodes 103A-n and remediation of the operation, as required, to enable efficient and timely operation of node cluster 102A-n and nodes 103A-n.

In an embodiment, the computer system 180 can further include a human-machine interface (HMI) 188 (e.g., a display, a graphical-user interface (GUI)) which can be configured to present various information including any of nodes 103A-n, node clusters 102A-n, workloads 138A-n, logs 108A-n, signatures 122A-n, actions 132A-n, reports 174A-n, causes 176A-n, actions 178A-n, etc., per the various embodiments presented herein. The HMI 188 can include an interactive display 189 to present the various information via various screens presented thereon, and further configured to facilitate input of thresholds H, signatures 122A-n, actions 132A-n, reports 174A-n, etc.

System 100 can further include a data historian 196 configured to compile historical data 195A-n (e.g., prior and/or current data/information/knowledge) regarding operation of file system 101A-n, node clusters 102A-n, nodes 103A-n, FAC 110, analyzer component 120, orchestration component 130, technical support system 170, and such, including logs 108A-n, signatures 122A-n, actions 132A-n, reports 164A-n, causes 176A-n, actions 178A-n, etc., with regard to enable efficient and timely operation of node cluster 102 and nodes 103A-n.

System 100 can further include a process component 193 and processes 194A-n. In an embodiment, processes 194A-n can include artificial intelligence (AI) and machine learning (ML) processes which can be utilized review logs 108A-n, identify one or more signatures 122A-n having content matching, or similar to, content of logs 108A-n, and further identify/recommend an action(s) 132A-n associated with the identified signature 122A-n, wherein the action(s) 132A-n was previously implemented to address the identified signature 122A-n. As mentioned, content of the respective log 108A-n does not have to exactly match content of a signature 122A-n, a similarity threshold H can be defined/applied (e.g., by tech support 172A-n) to the analyzer component 120 and/or the process component 193, whereby, if the degree of similarity indexes S₁₋ₙ between a first vector V₁, determined for first content of a first log 108A and a second vector V₂, determined for second content of a signature 122A-n, is equal to, or greater than H, the signature 122A-n (and associated action 132A-n) may provide a suitable/effective remediation of the fail condition of the node 103A-n of concern, as further described.

It is to be appreciated that while process component 193 and processes 194A-n, data historian 196 and historical data 195A-n are depicted as being included/coupled to computer system 180, process component 193 and processes 194A-n, data historian 196 and historical data 195A-n and be located and implemented at any suitable location/activity/process undertaken across system 100.

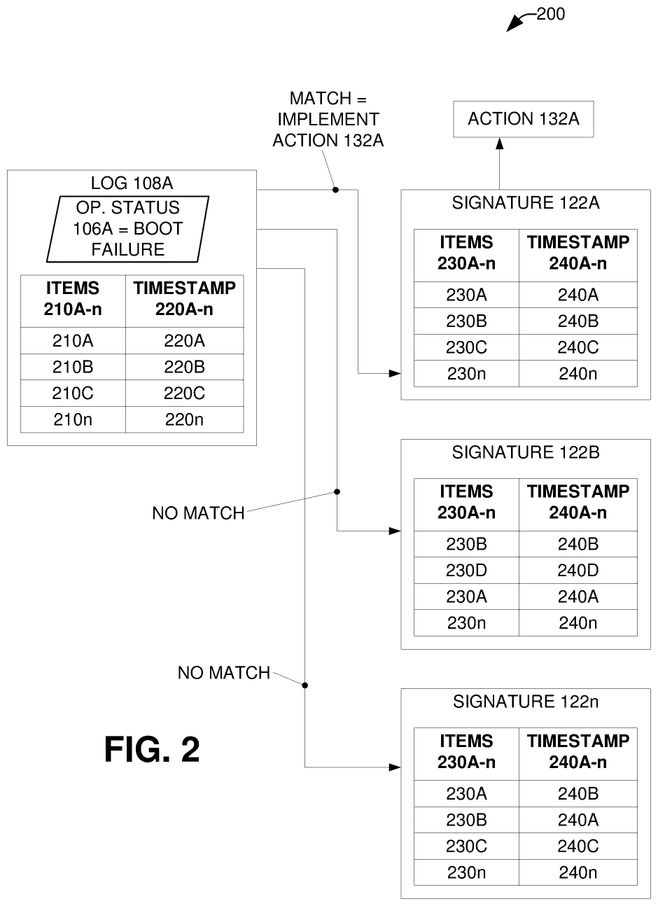

FIG. 2, schematic 200, illustrating a matching process occurring between content of an operational log and content of one or more signatures, in accordance with an embodiment. As shown, a log 108A has a status 106A of boot failure and further, includes a list of respective items 210A-n in conjunction with a series of timestamps 220A-n. A series of potential signatures 122A-n are also presented, which further include items 230A-n and timestamps 240A-n are listed, wherein items 210A-n and 230A-n can be comparable, and timestamps 220A-n and 240A-n can be comparable. As previously mentioned, analyzer component 120 can be configured to compare the content (items 210A-n and timestamps 220A-n) of log 108A with content (e.g., items 230A-n and timestamps 240A-n) of potentially matching signatures 122A-n. In the event of both items 210A-n and their chronological sequence, per timestamps 220A-n match items 230A-n and their chronological sequence, per timestamps 240A-n, a match between log 108A and a signature 122A has occurred. In the event of items 210A-n in log 108A are not present in a signature 122A-n (e.g., as items 230A-n) or items 210A-n in log 108A are present in a signature 122A but are not chronologically similar (e.g., sequence of items 210A-n/timestamps 220A-n does not match sequence of items 230A-n/timestamps 240A-n), then no match has occurred. Accordingly, per FIG. 2, log 108A was determined (e.g., by analyzer component 120) to match with signature 122A but not match with signatures 122B or 122n. Hence, orchestration component 130 can be configured to implement action 132A associated with signature 122A. Any suitable technology/technique can be utilized by the analyzer component 120 to perform the matching operation, e.g., pairing via regular expression matching (regex), or other processes 194A-n. During matching of items 210A-n with items 230A-n, the first item pairing 210A/230A with timestamps 220A/240A can be put aside and the next, second items 210B/230B can be found paired in the respective timeline objects (e.g., timestamps 220B/240B), and so on, working through the respective items 210A-n/230A-n and the respective timeline objects/timestamps 220A-n/240A-n.

The following code is an example of a RCA signature 122A, where, in the example, the code has a JSON Schema:

```
  “RCA” : “Planned Maintenance: Blown Journal”
  “remediation_workflow”: “PowerScale-VM-Replacement”
  “timeline” : [
    { “regex”: “isi_hwmon[\d+]:\s+ Scheduled maintenance
      event type: Reboot”,
      “logfile”: “/var/log/isi_hwmon” },
    { “regex”: “<<BOOT>>”,
      “logfile”: “/var/log/messages” },
    { “regex” : “isi_testjournal[\d+]:\s+ DRAM and disk backup are
invalid”,
      “logfile”: “/var/log/messages” }
```

### Example Code for Signature 122A-n and Action 132A-n

Per the example code above, the signature 122A has an RCA title defining the type of signature being looked for (e.g., blown journal resulting from planned maintenance).

Remediation workflow indicates the action 132A-n to be executed for signature 122A. The timeline is reviewed, e.g., using regex matching, to determine the respective items (e.g., items 210A-n and 230A-n) are present and are in the same chronological order, per timestamps (e.g., timestamps 220A-n and 240A-n, per FIG. 2) match. E.g., stepping through the example code, scheduled maintenance event type: Reboot, DRAM and disk back up are invalid, etc.

### 3. SEQUENCE DIAGRAM

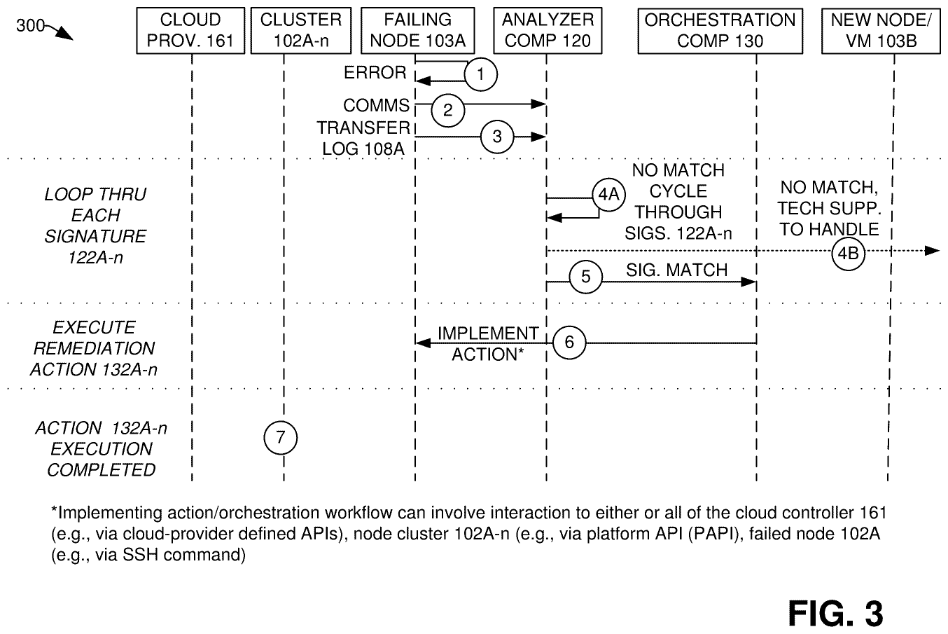

FIG. 3, schematic 300, presents a sequence diagram illustrating respective steps/operations performed during remediation of an orphaned node, in accordance with one or more embodiments.

At 3.1: status component 104A determines node 103A is in an error condition, and the boot process is stopped/terminated (e.g., by isi_stop_boot script). The log component 107A at node 103A further compiles log 108A comprising data 105A-n and status information 106A-n.

At 3.2: communication between node 103A and FAC 110 is established to enable communications 197A-n.

At 3.3: node 103A/log component 107A transfers the log 108A to analyzer component 120 at the FAC 110. Analyzer component 120 includes a set of signatures 122A-n and orchestration component 130 includes a set of remediation actions 132A-n associated with the signatures 122A-n.

At 3.4A/B and 3.5, a loop operation whereby the analyzer component 120 is configured to compare content (e.g., data 105A-n comprising items 210A-n and timestamps 220A-n) in log 108A with the content (e.g., items 230A-n and timestamps 240A-n) of the respective signatures in the set of signatures 122A-n.

At 3.4A, for each signature 122A-n, in the event of no match is identified (e.g., by analyzer component 120) between log 108A and the respective signature 122A-n, the next signature (e.g., signature 122A+1) in the set of signatures 122A-n is applied, until no more signatures 122A-n are to be compared with the content of log 108A. Effectively, where no match is determined, analyzer component 120 performs a for-next loop to compare the next signature 122A-n with the log 108A. At 3.4B, in the event of no matches are found, sequence 300 can exit (e.g., to tech support system 170).

At 3.5, for each signature 122A-n, in the event of a match is identified (e.g., by analyzer component 120) between log 108A and the respective signature 122A-n, the orchestration component 130 is configured to identify the action 132A associated with the matching signature 122A, and forward the action 132A (including node 103A/node cluster 102A identifiers) to remediation component 109A at node 103A. Remediation component 109A can be configured to apply the action 132A at node 103A, e.g., in an attempt to re-merge the failed node 103A with the node cluster 102A. In an embodiment, at 4 and 5, log 108A may be matched with more than one signature 122A-n/action 132A-n. For example, analyzer component 120 determines that while there is no exact match between log 108A and the available signatures 122A-n, two or more signatures 122A-n may be identified that match log 108A with a threshold degree of certainty H. Hence, in an embodiment, rather than the analyzer component 120 being configured to determine exact matches between log 108A and the prior signatures 122A-n, analyzer component 120 can function within an acceptable/defined level of certainty in matching log 108A with signatures 122A-n, for which potential actions 132A-n can be identified for implementation at node 103A.

At 3.6, action 132A (e.g., functioning as a remediation workflow) can be executed at node 103A by remediation component 109A. Further, the action 132A can be implemented at any of cloud-based computer system 160/cloud control component 161, node cluster 102A/cluster control component 150, at node 103A/remediation component 109, etc. Interaction between the remediation component 109 and the failed node 103A, e.g., in implementing action 132A, can be in any suitable form, e.g., via SSH commands (e.g., in communication 197A-n). Interaction between the cluster control component 150 and node cluster 102A-n can be via a platform API (PAPI). Interaction between the cloud control component 161 and the cloud system 160/file system 101A-n can be via a cloud provider-defined API 162A-n.

In the event of any of the analyzer component 120 or the remediation component 109 deem node 103A is unrecoverable, a node replacement action/workflow can be initiated, a.k.a., a smartfail failed node operation (e.g., an action 132X).

Further, any of the orchestration component 130 or the remediation component 109 can be configured to enact an action 132Y to create a new node 103Y. In the event of node 103A is not recoverable by an action 132A, e.g., the orphan node 103A cannot be incorporated into the existing node cluster 102A, at 3.8A and 3.8B, a new node 103B can be generated/created (e.g., by remediation component 109) with action 132X, which, at cluster 102A-n, the new node 103B can be implemented with/incorporated into existing cluster 102A.

With action 132A-n execution completed, and with node 103A being recoverable, the existing node 103A and/or node cluster 102A is remedied and rebooted, with the orphaned node 103A re-merged with the node cluster 102A.

At 3.7, per the foregoing, with a cluster 102A now including a new node 103B (in the event of the prior node 103A is unrecoverable) or node 103A can be re-merged into cluster 102A (in the event of the node 103A is recoverable), cluster 102A can be considered to be whole once more, e.g., based on the full node replacement and/or a reboot operation of the cluster 102A with new node 103B, or remediated node 103A.

### 4. METHODS FOR REMEDIATING A FAILED NODE/SYSTEM

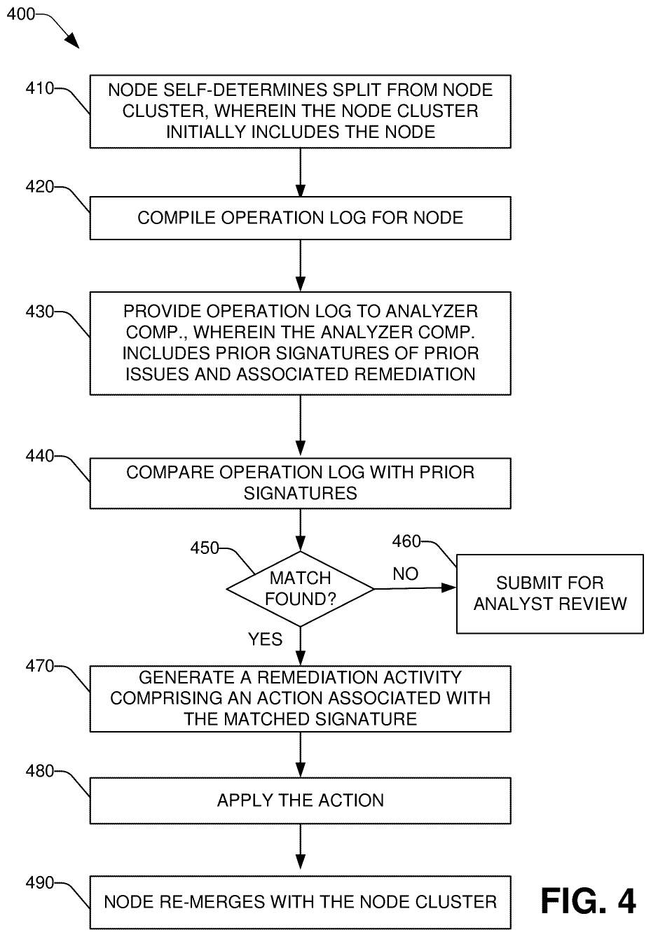

FIG. 4, via flowchart 400, presents an example computer-implemented method for automatically remediating a consequence of a failed node in a node cluster, in accordance with one or more embodiments.

At 410, a status component (e.g., status component 104A) can be configured to monitor operation of a node (e.g., node 103A), wherein the node is included in a cluster of nodes (e.g., node cluster 102A). The status component self-determines the node is in a state (e.g., status 106A) of failure. For example, during a boot operation of the cluster of nodes, the node undergoes a boor failure and is orphaned from the cluster of nodes.

At 420, a log component (e.g., log component 107A) can be configured to generate an operation log (e.g., log 108A) having content (e.g., data 105A-n) relating to operation of the node, e.g., up to and including when the node was determined to fail.

At 430, the log component can be configured to forward the operation log to a failure analysis component (e.g., FAC 110), wherein the status component and log component can be located/operating at the node, while failure analysis component can be remotely located from the node. The failure analysis component can include an analyzer component (e.g., analyzer component 120) that includes a set of signatures (e.g., signatures 122A-n).

At 440, the analyzer component can be configured to compare content (e.g., items 210A-n and timestamps 220A-n) of the operation log with respective content (e.g., items 230A-n and timestamps 240A-n) of the signatures. As previously mentioned, the analyzer component is not required to find exact matches between the respective content, but rather implement similarity matching based on a similarity threshold H.

At 450, in response to a determination by the analyzer component that NO matches were found between the content of the operation log and the content of the signatures, method 400 can advance to step 460, whereupon the analyzer component determines that the status and events leading to the node splitting from the node cluster are not present in any of the prior signatures. The analyzer component can be further configured to forward the operation log for further review at tech support (e.g., technical support system 170 and system engineers 172A-n). In an embodiment, forwarding the operation log can function as a notification (e.g., in communication 197N) that no matches were found.

At 450, in response to a determination by the analyzer component that YES, a match was found between the content of the operation log and the content of the signatures, method 400 can advance to step 470, whereupon the analyzer component determines that the status and events leading to the node splitting from the node cluster are present in a prior signature. The analyzer component can be further configured to notify an orchestration component (e.g., orchestration component 130) of the signature matching the content of the operation log. The orchestration component can be configured to identify a remediation action (e.g., action 132A) associated with the matched signature.

At 480, the remediation action can be forwarded to the respective component to which the action pertains, e.g., to the node (e.g., remediation component 109), to the cluster of nodes (e.g., cluster control component 150), to a cloud provider/file system (e.g., cloud control component 161 at cloud system 160/file system 101A-n), and such. The respective component receiving the action can be configured to implement the action.

At 490, as a function of implementing the action, in an example embodiment, the orphan node can be re-merged with the cluster of nodes. Alternatively, the action can result in a new node (e.g., node 103N) being generated for application with the cluster of nodes, a new cluster of nodes is generated, a different data server is brought online, operation of the file system (e.g., file system 101A) or the cloud computing system (e.g., cloud system 160) can be reconfigured, etc.

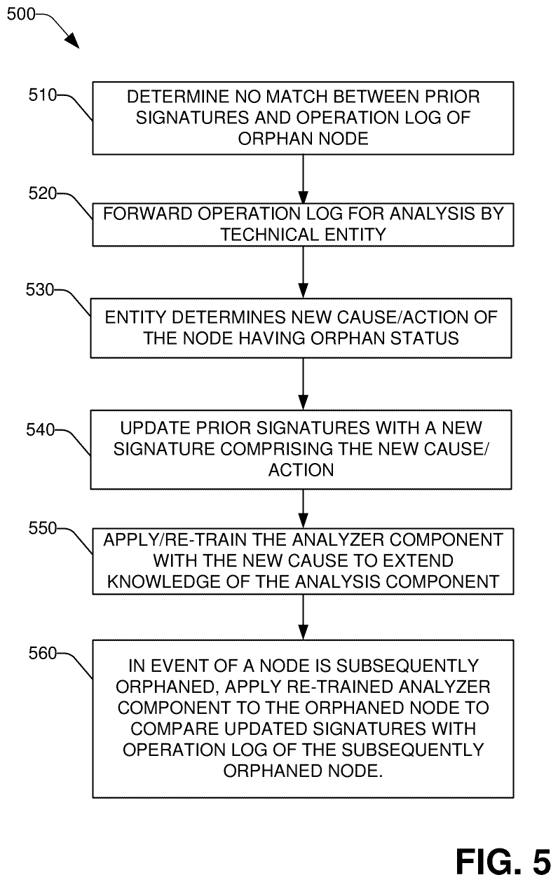

FIG. 5, via flowchart 500, presents an example computer-implemented method for determining remediation of a node and re-training of a process to automatically remediate the node, in accordance with one or more embodiments.

At 510, as previously mentioned (per FIG. 4, step 450), an analyzer component (e.g., analyzer component 120) can be configured to determine that NO matches were found between the content of an operation log (e.g., log 108A) of a node (e.g., node 103A) and the content of potential signatures (122A-n).

At 520, the analyzer component can be configured to forward the operation log to an entity at tech support (e.g., tech support system 170 and engineers 172A-n), for further analysis of the operation log.

At 530, analysis (e.g., by engineer 172A) of the operation log identifies/determines a new cause (e.g., cause 176A-n) for the node failure and further identifies a new remediation action (e.g., action 178A) to be implemented to address the failed state of the node. A report (e.g., report 174A) can be generated, reporting/combining the new cause with the new action and the data (e.g., data 105A, items 210A-n, timestamps 220A-n). The report can be transmitted from the tech support system to the analyzer component.

At 540, the analyzer component can be configured to utilize content of the report to generate a new signature (e.g., signature 122N). The set of prior signatures (e.g., signatures 122A-H) can be updated to include the new signature.

At 550, the new signature can also be utilized to retrain any AI/ML processes (e.g., processes 194A-n) configured to automatically match a log (e.g., logs 108A-n) with the set of signatures (e.g., signatures 122A-H+122N).

At 560, as new signatures are defined/identified in response to a node subsequently failing, where the node subsequently fails in a manner not previously encountered, the processes (e.g., analyzer component 120, processes 194A-n) can be re-trained with the newly defined signature(s). Accordingly, the processes can be improved/updated as nodes fail in a manner not previously encountered and new signatures are generated.

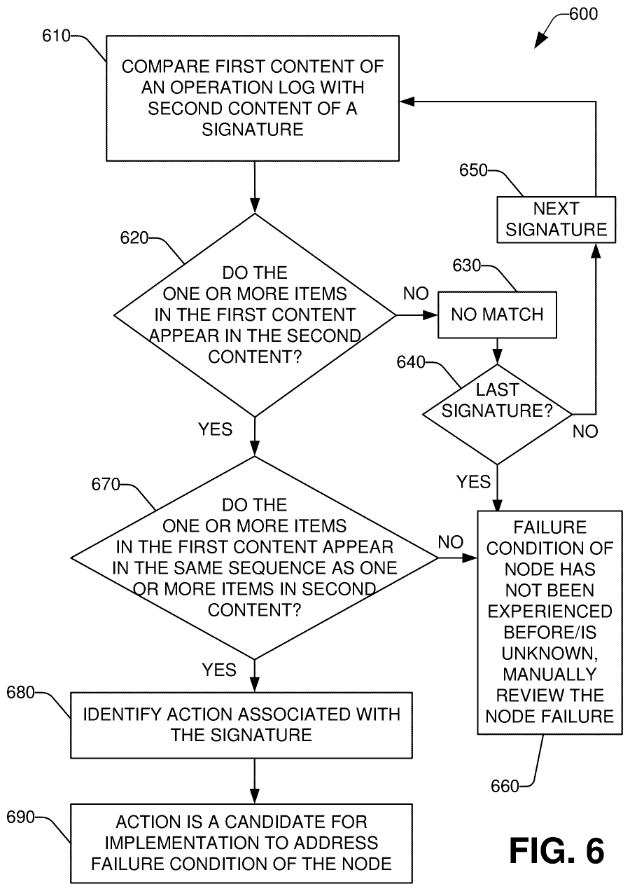

FIG. 6, via flowchart 600, presents an example computer-implemented method for automatically remediating a consequence of a failed node in a node cluster, in accordance with one or more embodiments.

At 610, an analyzer component (e.g., analyzer component 120) can be configured to compare first content (e.g., data 105A comprising items 210A-n/timestamps 220A-n) of an operation log (e.g., log 108A) of a failed node (e.g., node 103A) with second content (e.g., items 230A-n and timestamps 240A-n) included in respective signatures in a set of signatures (e.g., signatures 122A-n).

At 620, for a first signature (e.g., signature 122A), the analyzer component can be configured to determine whether items in the first content matches items in the second content. In response to a determination by the analyzer component that NO items in the first content matches any items in the second content, method 600 can advance to step 630, whereupon the analyzer component can be further configured to indicate that there is NO match between the first signature and the content of the operation log. Method 600 can further advance to step 640, whereupon the analyzer component can be further configured to determine if the first signature is the last signature available to be compared with the operation log. In response to a determination by the analyzer component that NO, the first signature is not the last available signature, method 600 can advance to step 650, whereupon the next signature can be obtained for comparison with the operational log, with method 600 returning to step 610 for the comparison to be performed.

Returning to step 640, in the event of the signature (e.g., first signature, next signature) is determined by the analyzer component to be the last available signature, and no matches have been identified, method 600 can advance to step 660, whereupon the failure condition of the node, as represented in the operational data, has not been experienced before, and further review of the node failure is required, per FIG. 5.

Returning to step 620, in response to a determination by the analyzer component that YES the first items (e.g., items 210A-n) match the second items (e.g., items 230A-n), method 600 can advance to step 670. At 670, the analyzer component can be further configured to determine whether the respective first timestamps (e.g., timestamps 220A-n for the items 210A-n) are in the same chronological sequence as the second timestamps (e.g., timestamps 240A-n for the items 230A-n), e.g., per FIG. 2. At 670, in response to a determination by the analyzer component that NO, the first timestamps are not in the same chronological order as the second timestamps, method 600 can advance to step 660, whereupon the failure condition of the node, as represented in the operational data, has not been experienced before, and further review of the node failure is required, per FIG. 5.

At 670, in response to a determination by the analyzer component that YES, the first timestamps are in the same chronological order as the second timestamps, method 600 can advance to step 680, whereupon the signature is determined to be matching and an orchestration component (e.g., orchestration component 130) can be configured to identify an action (e.g., action 132A) associated with the matched signature. Method 600 can further advance to step 690, whereupon the identified action can be implemented to remediate an effect of the failed node.

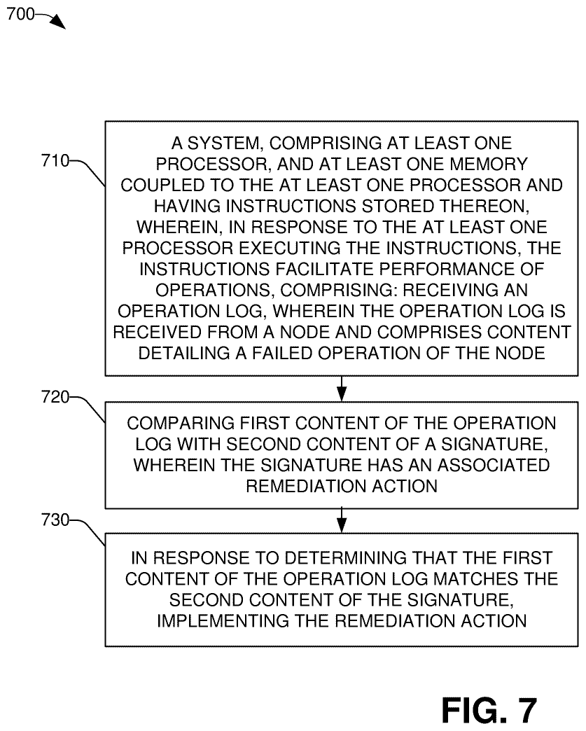

FIG. 7 presents an example computer-implemented method for automatically remediating a consequence of a failed node in a node cluster, in accordance with one or more embodiments. At 710, the process 700 can comprise a system, comprising at least one processor (e.g., processor 182), and at least one memory (e.g., memory 184) coupled to the at least one processor and having instructions stored thereon, wherein, in response to the at least one processor executing the instructions, the instructions facilitate performance of operations, comprising: receiving an operation log (e.g., log 108A), wherein the operation log is received from a node (e.g., node 103A) and comprises content detailing a failed operation (e.g., status 106A) of the node. At 720, process 700 can further comprise an operation comparing first content (e.g., items 210A-n/timestamps 220A-n) of the operation log with second content (e.g., items 230A-n/timestamps 240A-n) of a signature (e.g., signature(s) 122A-n), wherein the signature has an associated remediation action (e.g., action(s) 132A-n). At 730, process 700 can further comprise an operation of, in response to determining that the first content of the operation log matches the second content of the signature, implementing the remediation action.

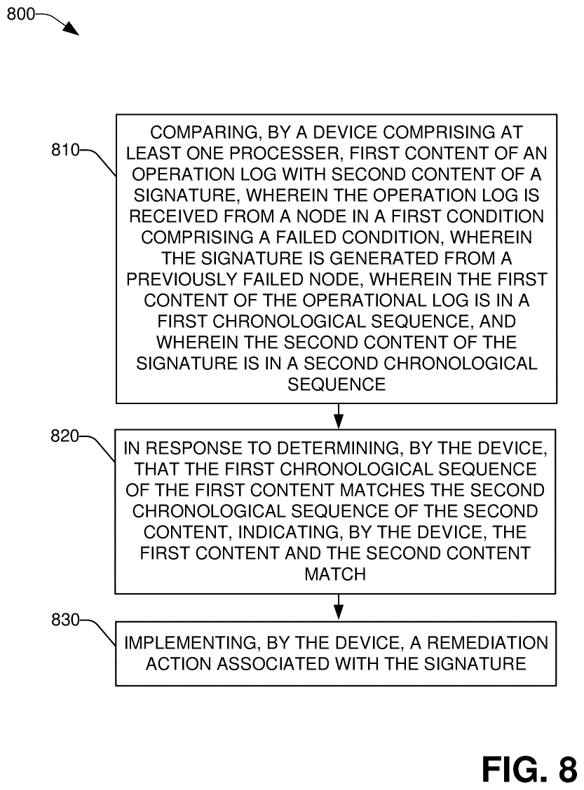

FIG. 8 presents an example computer-implemented method for automatically remediating a consequence of a failed node in a node cluster, in accordance with one or more embodiments. At 810, the process 800 can comprise comparing, by a device (e.g., FAC 110) comprising at least one processer (e.g., processor 182), first content (e.g., items 210A-n/timestamps 220A-n) of an operation log (e.g., log 108A) with second content (e.g., items 230A-n/timestamps 240A-n) of a signature (e.g., signature(s) 122A-n), wherein the operation log is received from a node (e.g., node 103A) in a first condition (e.g., status 106A) comprising a failed condition, wherein the signature is generated from a previously failed node (e.g., any of node 103A-n), wherein the first content of the operational log is in a first chronological sequence, and wherein the second content of the signature is in a second chronological sequence. At 820, process 800 can further comprise in response to determining, by the device, that the first chronological sequence of the first content matches the second chronological sequence of the second content, indicating, by the device, the first content and the second content match. At 830, process 800 can further comprise implementing, by the device, a remediation action (e.g., action 132A) associated with the signature.

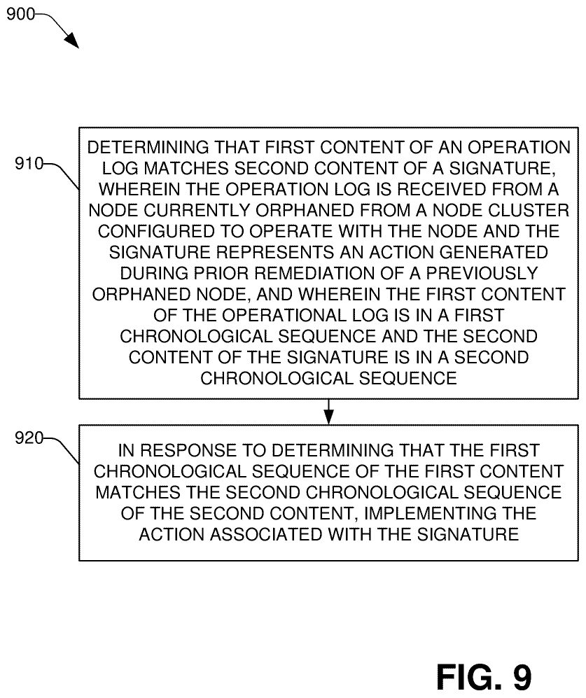

FIG. 9 presents an example computer-implemented method for automatically remediating a consequence of a failed node in a node cluster, in accordance with one or more embodiments. At 910, the process 900 can be performed by a computer program product stored on a non-transitory computer-readable medium and comprising machine-executable instructions, wherein, in response to being executed, the machine-executable instructions cause a system (e.g., FAC 110) to perform operations, comprising determining that first content (e.g., items 210A-n) of an operation log (e.g., log 108A) matches second content (e.g., items 230A-n) of a signature (e.g., signature 122A), wherein the operation log is received from a node (e.g., node 103A) currently orphaned from a node cluster (e.g., 102A) configured to operate with the node and the signature represents an action (e.g., action 132A) generated during prior remediation of a previously orphaned node (e.g., node 103A-n), and wherein the first content of the operational log is in a first chronological sequence (e.g., per timestamps 220A-n) and the second content of the signature is in a second chronological sequence (e.g., per timestamps 240A-n). At 920, process 900 can further comprise in response to determining that the first chronological sequence of the first content matches the second chronological sequence of the second content, implementing the action associated with the signature.

### 5. APPLICATION/IMPLEMENTATION OF AI & ML

As mentioned, the various embodiments presented herein can utilize various AI/ML model/technology/technique/architecture (e.g., process component 193 implementing processes 194A-n). AI/ML technologies and techniques can be configured to determine information, make inferences, predictions, etc., regarding identifying a signature 122A-n having content that matches/is similar to content in a log 108A-n, and further identifying and recommending an action 132A-n to automatically enable re-merging of a node 103A-n into node cluster 102A-n, e.g., on a file system 101A-n, such as a data server.

Processes 194A-n can include AI, ML, and reasoning techniques/technologies that employ probabilistic and/or statistical-based analysis to prognose or infer an action that an entity desires to be automatically performed for carrying out various aspects thereof, e.g., automatically identifying signatures 122A-n/actions 132A-n to enable a node 103A-n to re-merge with a node cluster 102A-n, delete a node 103A-n, and suchlike, which as mentioned, can be facilitated via an automatic classifier system and process. A classifier can be a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (as further described below). For example, SVM's are configured via a learning or training phase within a classifier constructor and feature selection module, e.g., included in process component 193. Thus, the classifier(s) can be used to automatically learn and perform a number of functions, including but not limited to, determining according to predetermined criteria, e.g., identifying a signature 122A-n and associated action 132A-n for implementation at a node 103A-n with a log 108A-n having content matching/comparable to signature 122A-n and associated action 132A-n, and suchlike.

In an example embodiment, processes 194A-n can be trained/fine-tuned with previously obtained/generated data (e.g., in historical data 195A-n, previously implemented signatures 122A-n, actions 132A-n, causes 176A-n, actions 178A-n, and such). Fine-tuning of a process 194A-n can comprise application, to processes 194A-n, of previously implemented signatures 122A-n and actions 132A-n applied to logs 108A-n, as well as causes 176A-n and actions 178A-n implemented at technical support system 170, and suchlike. Processes 194A-n can be correspondingly adjusted by the ability of the processes 194A-n (process component 193, and any associated component across system 100 utilizing processes 194A-n) to successfully/or unsuccessfully determine any of a previously defined signature 122A-n/action 132A-n and/or causes 176A-n/actions 178A-n that corresponds to, matches, satisfies, or substantially satisfies, a similarity criterion (e.g., ≥H) pertaining to/determined for content of a log 108A-n for which a remediation of a fail condition of a node 103A-n is being sought. For example, weightings in the process 194A-n are adjusted by application of the ability to accurately determine a previously defined signature 122A-n/action 132A-n that is suitable for application with a node 103A-n currently undergoing a fail condition, per content of log 108A-n, and such. During training, prior decisions, prior observations, determinations, etc., can be applied to the processes 194A-n, enabling the processes 194A-n to be trained regarding correctly identifying a previously defined signature 122A-n/action 132A-n and/or newly determined causes 176A-n/actions 178A-n applicable for use with a failed/failing node 103A-n included in node cluster 102A-n. Accordingly, when new information is provided (e.g., new content in logs 108A-n, new causes 176A-n, new actions 178A-n, and suchlike), processes 194A-n can be retrained accordingly.

In an example, processes 194A-n can be configured to be implemented by the signature component 120 and/or the orchestration component 130 to assist with identifying an action 132A-n/168A-n that can be implemented to remediate a failed/failing node 103A-n, as a well as, for example, take the node 103A-n offline, and suchlike. Processes 194A-n can be utilized to review previously identified/implemented signatures 122A-n/actions 132A-n, logs 108A-n, causes 176A-n, actions 178A-n, etc., to determine, an action 132A-n/168A-n to be implemented for a currently considered log 108A-n associated with a failed/failing node 103A-n and/or node cluster 102A-n.

It is to be appreciated that the various processes 194A-n and operations presented herein are simply examples of respective AI and ML operations and techniques, and any suitable technology can be utilized in accordance with the various embodiments presented herein. In an example embodiment, process component 193/processes 194A-n can be applied to previously identified/implemented signatures 122A-n/actions 132A-n, logs 108A-n, causes 176A-n, actions 178A-n, etc., in historical data 195A-n, and such. Wherein, process component 193/processes 194A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is highly complex, for example, comprising billions of weighted parameters.

Accordingly, in an embodiment, implementation of system 100 and included/associated components, with processes 194A-n, enables natural language processing (NLP) (e.g., utilizing vectors) to identify a previously implemented action 132A-n/168A-n to be applied to a currently considered log 108A-n associated with a failed/failing node 103A-n and/or node cluster 102A-n.

### 6. EXAMPLE ENVIRONMENTS OF USE

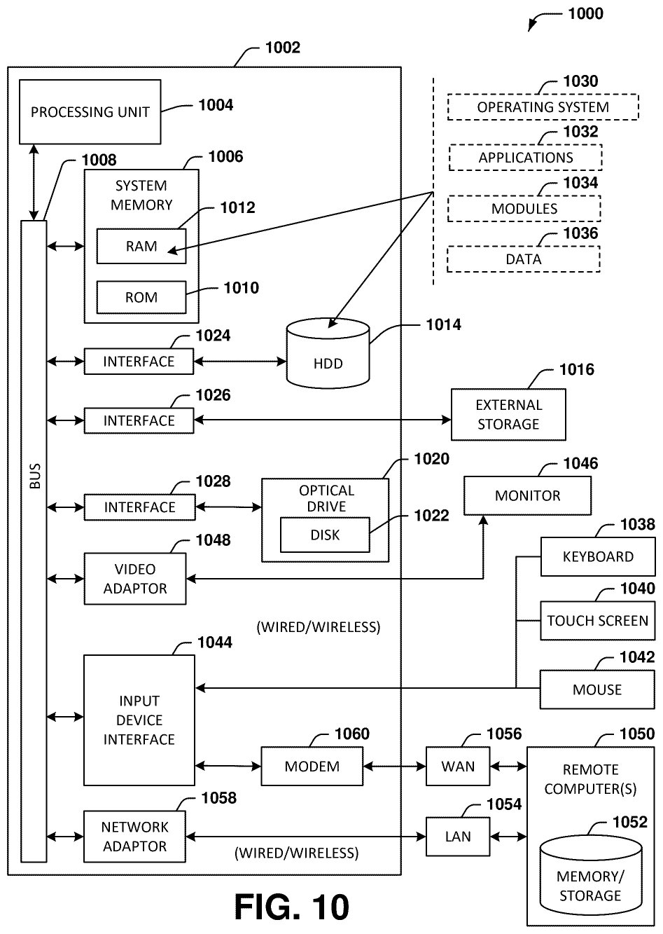

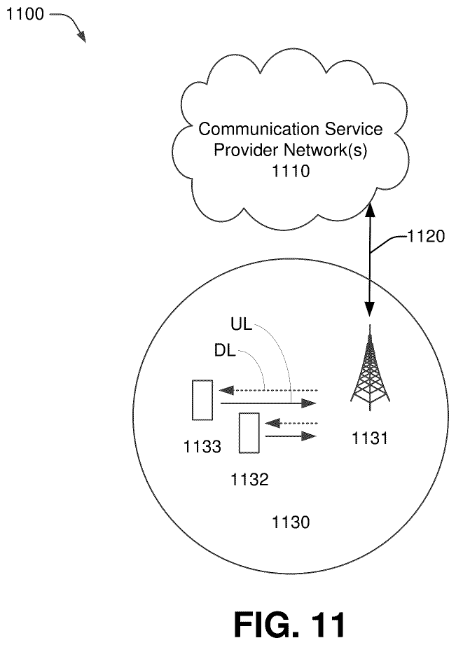

Turning next to FIGS. 10 and 11, a detailed description is provided of additional context for the one or more embodiments described herein with FIGS. 1-9.

In order to provide additional context for various embodiments described herein, FIG. 10 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1050 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1050 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 11 illustrates an example wireless communication system 1100, in accordance with one or more embodiments described herein. The example wireless communication system 1100 comprises communication service provider network(s) 1110, a network node 1131, and user equipment (UEs) 1132, 1133. A backhaul link 1120 connects the communication service provider network(s) 1110 and the network node 1131. The network node 1131 can communicate with UEs 1132, 1133 within its service area 1130. The dashed arrow lines from the network node 1131 to the UEs 1132, 1133 represent downlink (DL) communications to the UEs 1132, 1133. The solid arrow lines from the UEs 1132, 1133 to the network node 1131 represent uplink (UL) communications.

In general, with reference to FIG. 11, the non-limiting term “user equipment” can refer to any type of device that can communicate with network node 1131 in a cellular or mobile communication system 1100. UEs 1132, 1133 can have one or more antenna panels having vertical and horizontal elements. Examples of UEs 1132, 1133 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 1132, 1133 can also comprise IOT devices that communicate wirelessly.

In various embodiments, system 1100 comprises communication service provider network(s) 1110 serviced by one or more wireless communication network providers. Communication service provider network(s) 1110 can comprise a “core network”. In example embodiments, UEs 1132, 1133 can be communicatively coupled to the communication service provider network(s) 1110 via a network node 1131. The network node 1131 can communicate with UEs 1132, 1133, thus providing connectivity between the UEs 1132, 1133 and the wider cellular network. The UEs 1132, 1133 can send transmission type recommendation data to the network node 1131. The transmission type recommendation data can comprise a recommendation to transmit data via a closed loop multiple input multiple output (MIMO) mode and/or a rank-1 precoder mode.

Network node 1131 can have a cabinet and other protected enclosures, computing devices, an antenna mast, and multiple antennas for performing various transmission operations (e.g., MIMO operations) and for directing/steering signal beams. Network node 1131 can comprise one or more base station devices which implement features of the network node. Network nodes can serve several cells, depending on the configuration and type of antenna. In example embodiments, UEs 1132, 1133 can send and/or receive communication data via wireless links to the network node 1131.

Communication service provider networks 1110 can facilitate providing wireless communication services to UEs 1132, 1133 via the network node 1131 and/or various additional network devices (not shown) included in the one or more communication service provider networks 1110. The one or more communication service provider networks 1110 can comprise various types of disparate networks, including but not limited to: cellular networks, femto networks, picocell networks, microcell networks, internet protocol (IP) networks Wi-Fi service networks, broadband service network, enterprise networks, cloud-based networks, millimeter wave networks and the like. For example, in at least one implementation, system 1100 can be or comprise a large-scale wireless communication network that spans various geographic areas. According to this implementation, the one or more communication service provider networks 1110 can be or comprise the wireless communication network and/or various additional devices and components of the wireless communication network (e.g., additional network devices and cell, additional UEs, network server devices, etc.).

The network node 1131 can be connected to the one or more communication service provider networks 1110 via one or more backhaul links 1120. The one or more backhaul links 1120 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 1120 can also comprise wireless link components, such as but not limited to, line-of-sight (LOS) or non-LOS links which can comprise terrestrial air-interfaces or deep space links (e.g., satellite communication links for navigation). Backhaul links 1120 can be implemented via a “transport network” in some embodiments. In another embodiment, network node 1131 can be part of an integrated access and backhaul network. This may allow easier deployment of a dense network of self-backhauled 5G cells in a more integrated manner by building upon many of the control and data channels/procedures defined for providing access to UEs 1132, 1133.

Wireless communication system 1100 can employ various cellular systems, technologies, and modulation modes to facilitate wireless radio communications between devices (e.g., the UEs 1132, 1133 and the network node 1131). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 1100 can operate in accordance with any 5G, next generation communication technology, or existing communication technologies, various examples of which are listed supra. In this regard, various features and functionalities of system 1100 are applicable where the devices (e.g., the UEs 1132, 1133 and the network node 1131) of system 1100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 1100 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example, several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 9 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities. The terms “set” and “group” are used interchangeably herein.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G, O-RAN, or other generation networks, the disclosed aspects are not limited to 5G or O-RAN implementations, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory coupled to the at least one processor and having instructions stored thereon, wherein, in response to the at least one processor executing the instructions, the instructions facilitate performance of operations, comprising:
receiving an operation log, wherein the operation log is received from a node and comprises content detailing a failed operation of the node;
comparing first content of the operation log with second content of a signature, wherein the signature has an associated remediation action; and
in response to determining that the first content of the operation log matches the second content of the signature, implementing the remediation action.

2. The system of claim 1, wherein the operation log indicates the node is in a first condition, wherein the first condition is the node being orphaned from a node cluster configured to include the node, wherein the remediation action places the node in a second condition, and wherein the second condition is the node is re-merged with the node cluster.

3. The system of claim 1, wherein the first content of the operation log comprises a first set of items, wherein each item in the first set of items has a respective timestamp, and the second content of the signature comprises a second set of items, wherein each item in the second set of items has a respective timestamp, and the operations further comprise:
determining that the first content of the operation log matches the second content of the signature based on:
the first set of items being determined to match the second set of items; and
a first chronological order of the first set of items being determined to match a second chronological order of the second set of items.

4. The system of claim 1, wherein the signature is a first signature included in a set of signatures, and wherein the operations further comprise, in response to determining the first content of the operation log does not match the second content of the first signature:
forwarding the operation log to an external review system;
receiving, from the external review system, a second signature generated based on the first content of the operation log; and
supplementing the set of signatures with the second signature.

5. The system of claim 1, wherein the operation log indicates the node is orphaned from a node cluster configured to include the node, and the remediation action comprises one of re-merging the node into the node cluster, replacing the orphaned node in the node cluster with a different node, or reconfiguring operation of computing equipment comprising the node cluster.

6. The system of claim 1, wherein the operation log is auto-generated by the node, and the system is remotely located from the node.

7. The system of claim 1, wherein the node is located in a computer system, and the node is one of a container node, a virtual machine, an application server, a data server, or a user device.

8. The system of claim 1, wherein the operations further comprise:
transmitting the remediation action to the node for implementation of the remediation action at the node;
transmitting the remediation action to a cluster control process located at the node cluster for implementation of the remediation action at the node cluster; or
transmitting the remediation action to a cloud control process for implementation of the remediation action at a cloud computing system that comprises the node.

9. The system of claim 1, wherein the failed operation of the node causes the node to be orphaned from a node cluster configured to include the node, and the node is unable to communicate with another node in the node cluster.

10. The system of claim 1, wherein the remediation operation comprises rebooting the node.

11. A computer-implemented method comprising:
comparing, by a device comprising at least one processer, first content of an operation log with second content of a signature, wherein the operation log is received from a node in a first condition comprising a failed condition, wherein the signature is generated from a previously failed node, wherein the first content of the operational log is in a first chronological sequence, and wherein the second content of the signature is in a second chronological sequence; and
in response to determining, by the device, that the first chronological sequence of the first content matches the second chronological sequence of the second content:
indicating, by the device, the first content and the second content match; and
implementing, by the device, a remediation action associated with the signature.

12. The computer-implemented method of claim 11, wherein the first condition of the node is the node is orphaned from a node cluster configured to include the node, and a second condition of the node is the node is operational within the node cluster.

13. The computer-implemented method of claim 12, wherein the device is located remote from the node, and the node is unable to communicate with other nodes in the node cluster from which the node is orphaned.

14. The computer-implemented method of claim 11, wherein the node is located in a computer system, and the node is one of a container node, a virtual machine, an application server, a data server, or cloud computing equipment.

15. The computer-implemented method of claim 11, wherein the first condition of the node causes at least one of a node cluster configured to include the node to operate in a degraded state, a file system configured to include the node operates in a degraded state, or a cloud computing system configured to include the node operates in a degraded state.

16. The computer-implemented method of claim 15, wherein the remediation action comprises at least one of re-merging the node into the node cluster, replacing the orphaned node in the node cluster with a different node, or reconfiguring operation of at least one of the node cluster, the file system, or the cloud computing system.

17. A computer program product stored on a non-transitory computer-readable medium and comprising machine-executable instructions, wherein, in response to being executed, the machine-executable instructions cause a system to perform operations, comprising:
determining that first content of an operation log matches second content of a signature, wherein the operation log is received from a node currently orphaned from a node cluster configured to operate with the node and the signature represents an action generated during prior remediation of a previously orphaned node, and wherein the first content of the operational log is in a first chronological sequence and the second content of the signature is in a second chronological sequence; and
in response to determining that the first chronological sequence of the first content matches the second chronological sequence of the second content, implementing the action associated with the signature.

18. The computer program product according to claim 17, wherein the system is located off-cluster from the node, and the node is unable to communicate with other nodes in the node cluster from which the node is orphaned.

19. The computer program product according to claim 17, wherein the action comprises at least one of re-merging the node into the node cluster, replacing the orphaned node in the node cluster with a different node, or reconfiguring operation of at least one of the node cluster or computing equipment comprising the node cluster.

20. The computer program product according to claim 17, wherein the node is located in a computer system, and the node is one of a container node, a virtual machine, an application server, data server, or a user device.
